(19) United States
(12) Patent Application Publication
(10) Pub. No.: US 2009/0076880 A1
(43) Pub. Date: Mar. 19, 2009

(54) SYSTEM AND METHOD FOR MANAGING THE ACTIVITIES OF AN ORGANIZATION

(76) Inventor: Michael S. Kramer, Skokie, IL (US)

Correspondence Address: FALKOWSKI PLLC, P.O. BOX 650, NOVI, MI, 48376-0650, US

(21) Appl. No.: 12/140,233

(22) Filed: Jun. 16, 2008

Related U.S. Application Data
(60) Provisional application No. 60/944,095, filed on Jun. 14, 2007.

(51) Int. Cl. G06F 9/46; G06F 7/00; G06F 17/30

(52) U.S. Cl. 705/9; 707/102; 707/E17.048

(57) ABSTRACT

A management tool is disclosed that provides for the comprehensive management of the objectives, policies, tasks, documents, information and activities (collectively “activities”) to an organization. Activities across different levels of an organization and/or involving different groups within an organization can be managed using a single system. Metrics can be captured and analyzed at different levels in the organization. The tool enhances the ability of an organization to strategically align personnel and departments to facilitate the applicable objects and values of the organization. Transparency can be enhanced across different functional groups, and from top to bottom in the organization.

### RELATED APPLICATION

This utility patent application claims priority to a U.S. Provisional Patent Application titled “INFORMATION MANAGEMENT SYSTEM AND METHOD” (Ser. No. 60/944,095) that was filed on Jun. 14, 2007, the contents of which are hereby incorporated by reference in their entirety.

### BACKGROUND OF THE INVENTION

The invention relates generally to systems and methods for managing information. More specifically, the invention is a system and method for managing the activities of an organization (collectively the “system”).

Advances in information technology have greatly assisted efforts to manage organizations. Corporations, government agencies, non-profit groups, community organizations, religious groups, professional associations, hobby groups, and other organizations (collectively “organizations”) can benefit from a variety of different management tools. Unfortunately, such prior art tools are often one-dimensional and fragmented. Such tools often do not sufficiently empower groups and individuals within the organization to strategically align the various resources spread throughout the organization with the objectives of the organization as a whole. Moreover, such tools typically fail to integrate information relating to high-level objectives with more detailed information relating to the activities, documents, resources, and organizational groups necessary to achieve those objectives.

### SUMMARY OF THE INVENTION

The invention relates generally to systems and methods for managing information. More specifically, the invention is a system and method for managing the activities of an organization (collectively the “system”).

The system can be implemented in a wide variety of different embodiments. An organization subsystem can be used to define and track different resources within the organization, ranging from the organization as a whole and entire divisions and departments down to small teams and even individual employees and contractors. An activities subsystem can be used to define, monitor, and otherwise manage the activities performed at different levels within the organization. Managers within the organization can access roll-up or roll-down views of information that is important to group managed by the particular manager, while still being linked to goals and activities of the organization as a whole. Both the activities subsystem and the organization subsystem can define, process, and monitor information at different levels. Overarching organization goals can be tied to activities performed by departments which in turn can be tied to activities by teams and individual employees.

The system can be more fully understood upon reading the accompanying drawings that are discussed briefly below.

### BRIEF DESCRIPTION OF THE DRAWING

The following drawings illustrate different user interfaces the embody different examples and embodiments of the system.

FIG. 1 is an environmental diagram illustrating an example of certain hardware components that can be used to implement the system and some data elements that can be incorporated into the processing of the system.

FIGS. 2a-2b are hierarchy diagrams illustrating examples of organization hierarchies that can be incorporated into the processing of the system.

FIGS. 3a-3b are hierarchy diagrams illustrating examples of activity hierarchies that can be incorporated into the processing of the system.

FIGS. 4a-4b are hierarchy diagrams illustrating examples of process hierarchies that can be incorporated into the processing of the system.

FIGS. 5a-5c are block diagrams illustrating an examples of subsystem-level views of the system.

FIGS. 6a-6c are flow chart diagrams illustrating examples of process flows that can incorporated into the processing of the system.

Additional figures disclose examples of interface views that can be incorporated into the processing of the system.

### DETAILED DESCRIPTION

### I. Overview

The invention relates generally to systems and methods for managing information. More specifically, the invention is a system and method for managing the activities of an organization (collectively the “system”).

The system provides organizations with a comprehensive integrated tool to align the resources of the organization with the objectives of the organization. Organization-wide objectives can be directly linked with specific activities to be performed by different sub-organizations or groups within the organization. The system can provide a new way for leaders and their teams to collaborate, coordinate, develop, communicate, implement and monitor the evolving strategic, operational and tactical plans and processes needed to manage an organization and its divisions, departments, sub-departments, work-groups and employees. The system can allow organizations to integrate strategic planning, project management, team-communication, operational standardization, policy management, knowledgebase management, comprehensive internal assessments, and the review of individual employees into a fully-integrated enterprise-wide application that can be easily accessed by those in the organization. Convergence of these elements can result in new levels of transparency, accountability, data accessibility, historical reference, continuity planning, change-management, process improvement, culture-alignment, team-building, leadership-development, and strategic insight. The system can be used to leverage, manage and improve the core capabilities and human resource utilization of an organization for maximum efficiency, effectiveness and results.

The system can be implemented as a fully comprehensive and integrated system that simultaneously manages the people, processes, and strategies needed to create or strengthen the operational and leadership infrastructure of an organization. The system can be used to integrate leadership and management tools at all levels in an organization and utilize web methodologies to provide a fully integrated online system that simultaneously manages people, processes and strategies as they relate to an organizations evolving “business model.” The system as a whole can serve as an online interface between an organization and the people responsible for its development, operations, activities, management and oversight. A scaleable operational and leadership infrastructure can be used to support rapid growth while maintaining consistent quality and customer satisfaction. In many embodiments of the system, the system should not be characterized as “modular” because such embodiments do not merely throw together functions such as strategic planning, project management, team-communication, operational standardization, policy management, knowledgebase management, 360-degree assessment, and employee review as separate entities. To the contrary, such processing can be designed as part of an integrated system that presumes the comprehensive and integrated nature of the system. Such a framework can greatly enhance the ability of people within an organization to better strategically align the resources of different parts of an organization and to better pursue the objectives of the organization as a whole.

The system can be used to provide a comprehensive online representation of an organization's business model where people, processes and strategies can be shared, review, communicated, coordinated and even franchised to outside entities. Functionality relating to project management, strategic planning, operational standardization, knowledge management, employee management, team-communication, etc. can be fully integrated to provide a common leadership framework and management language designed to standardize every aspect of an organization including an effective leadership routine.

Use of the system can facilitate a wide variety of different organization goals, operations, and functions. By way of example, the system can be used as a team management tool. The system can facilitate the strategic alignment of all departments and employees with broad organizational objectives and values. The system can be used to achieve new levels of transparency and accountability as it relates to the design, implementation and reporting of an organization's qualitative as well as quantitative results.

The system can provide a unique way to represent an organization's business model and prepare it for a merger, acquisition, sale, or franchise activities. For example a pizza shop in New Jersey can easily teach an entrepreneur in Chicago everything they need to launch a similar business.

Continuity planning and talent management can be substantially enhanced through use of the system. The system can change the way that employees are reviewed and managed. Employees can take a more proactive role over their own careers, and take a part in the process of setting expectations and measurable performance goals in a career path that can serve both the organization and the individual employee.

Change management activities for an organization can be enhanced by the system. Business transformation and optimization can be achieved by empowering individuals and groups within the organization to better coordinate their activities with respect to organization-wide goals. The system can also be used to eliminate redundancy. By integrating a wide variety of different data elements, the need for stand-alone applications with those functions can be eliminated. The system provides a replacement for such applications that is a very structured leadership, management, and communication methodology that utilizes well understood management methods and techniques in a new, useful, and non-obvious way.

The system can be implemented in wide variety of different technical architectures. In some embodiments, the system is programmed in .net and should be permission based. One or more administrators with global authority can be empowered to assign permissions to an unlimited number of users, departments, etc. within an organization.

The evolving strategic, operational and tactical methods and plans involved in managing the organization and its employees can be connected together and integrated through use of the system. The system can assist executive management achieve the difficult tasks of achieving the strategic alignment of organization resources and activities, obtaining buy-in from employees throughout the organization, and establishing ownership throughout the organization in the strategic vision and the efforts it takes to fulfill organization goals. The system can be a tool that brings to life the organizations strategic functions, and allows—at all levels—full talent engagement and ownership in the organization's planned direction and growth. The system can revolutionize the operating environment of an organization because the leaders of the organization and their teams can communicate, collaborate, coordinate, develop, implement and monitor transparently using the system which can be implemented in a single intuitively user-friendly, fully integrated, and customizable web-based application.

The system can integrate best-management-practices related to strategic planning, project management, operational standardization, policy management, knowledge base management, 360-degree review, and talent management and review. The result is a new level of accountability, data accessibility, historical reference, and continuity of planning and strategic insight. The impact to the organization is optimized core capabilities and human resources to maximum efficiency and effectiveness.

### II. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

### III. Introduction of Elements and Definitions

The invention relates generally to systems and methods for managing information. More specifically, the invention is a system and method for managing the activities of an organization (collectively the “system”).

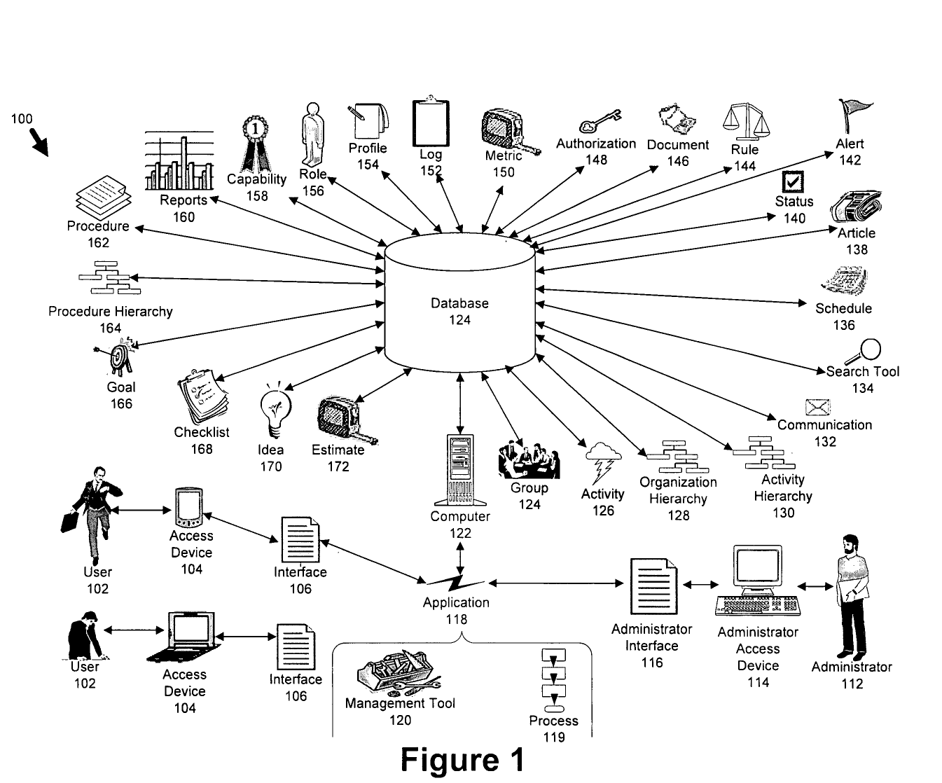

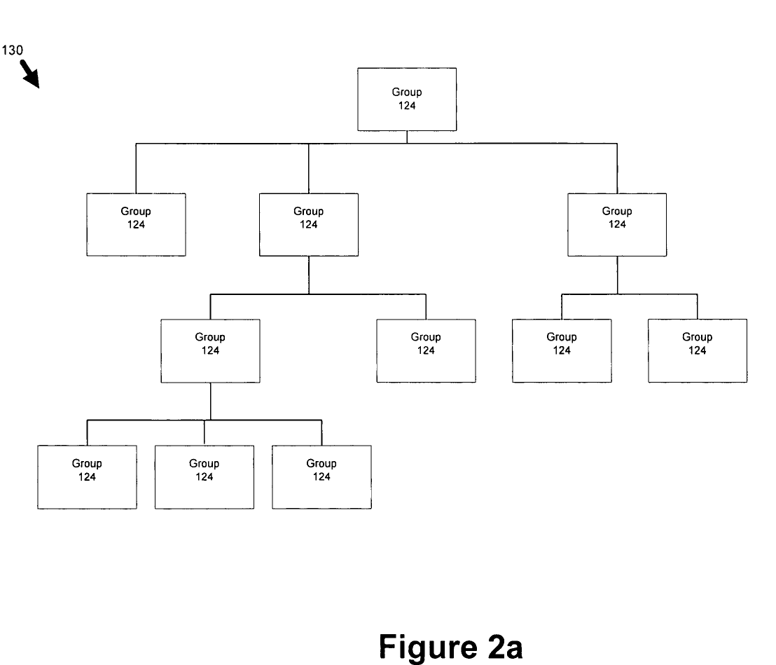

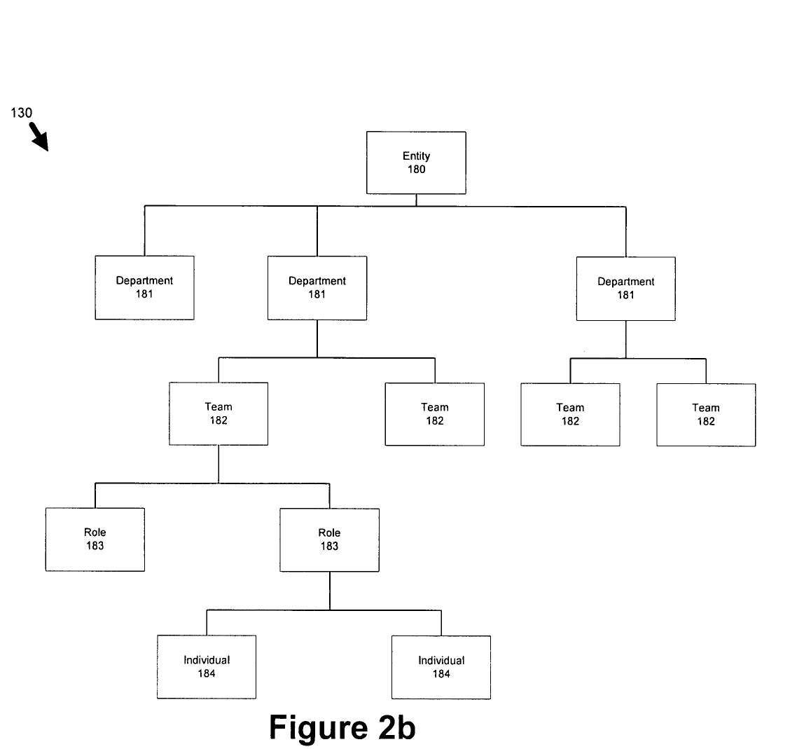

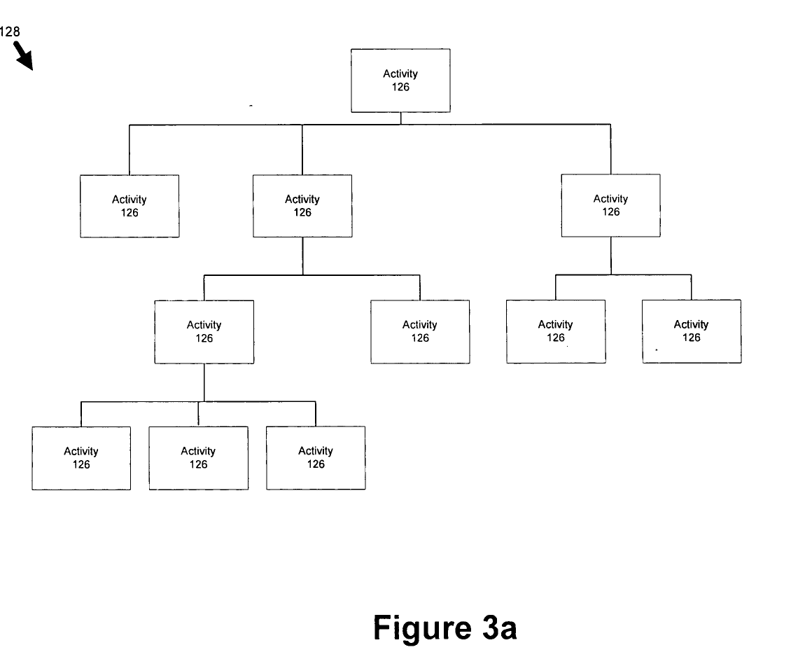

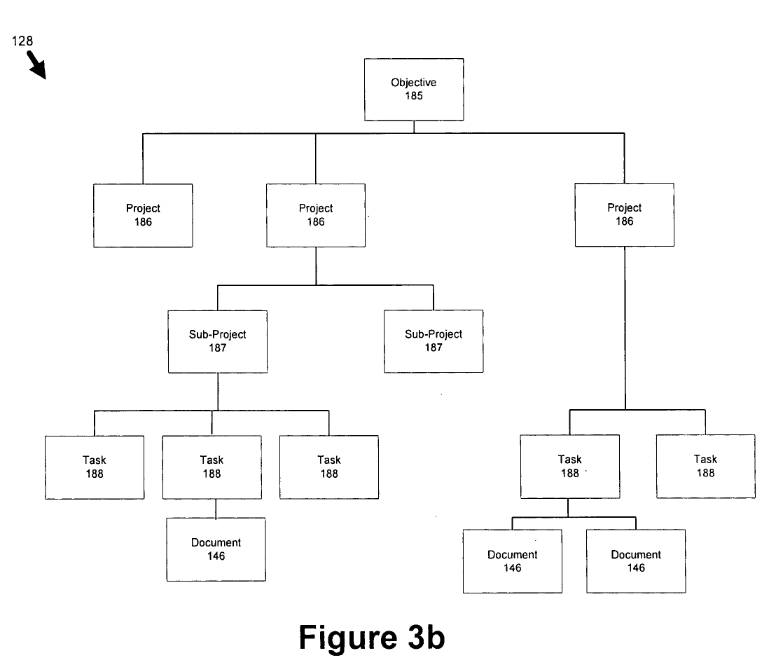

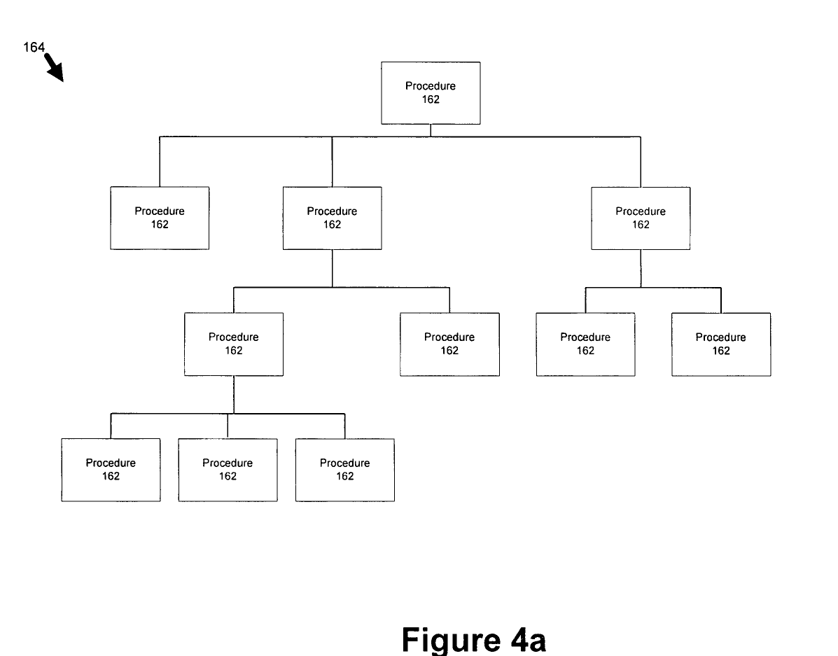

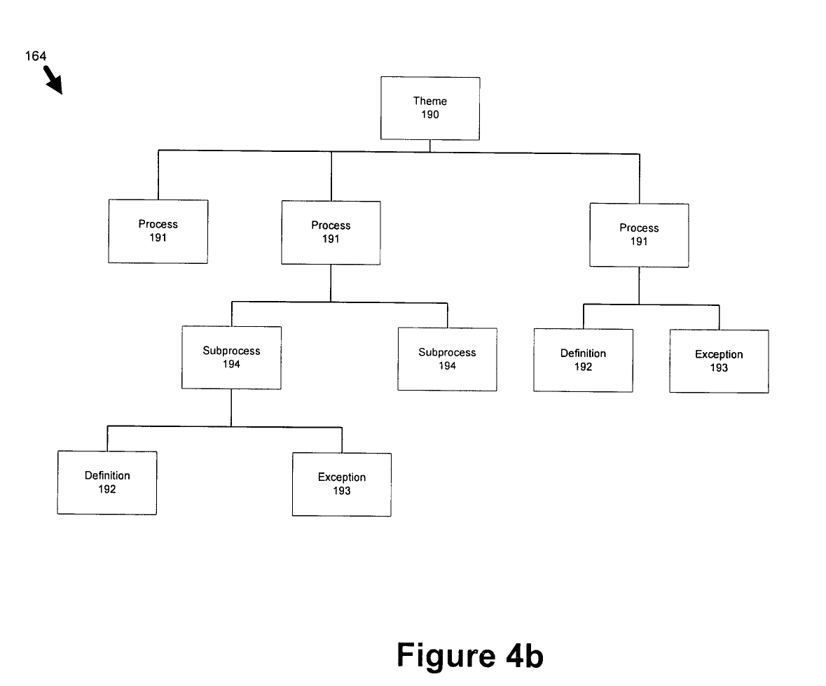

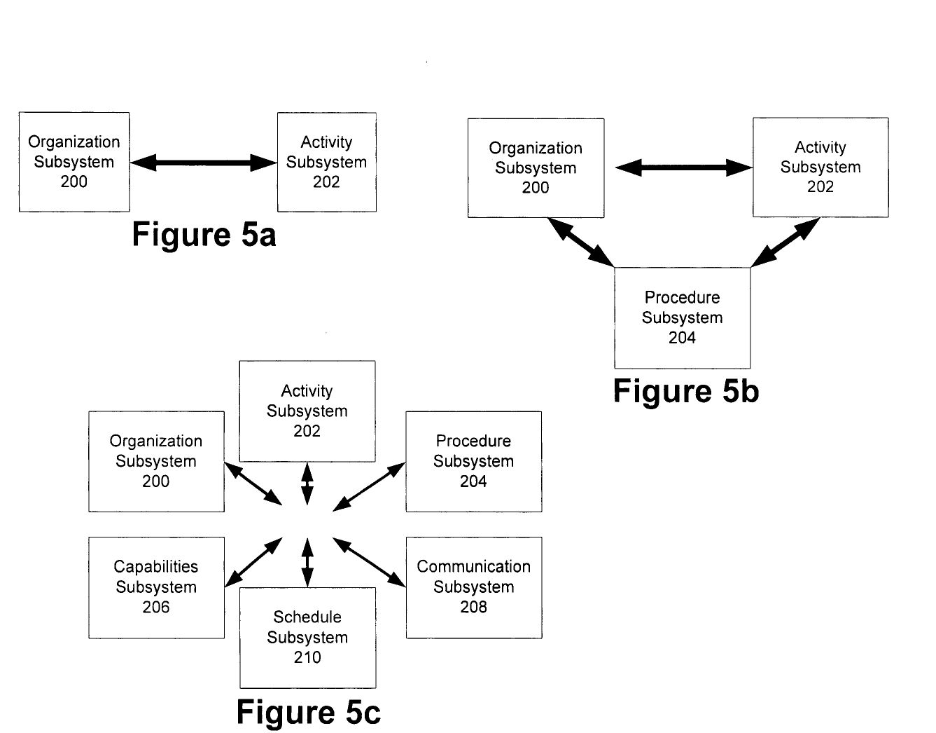

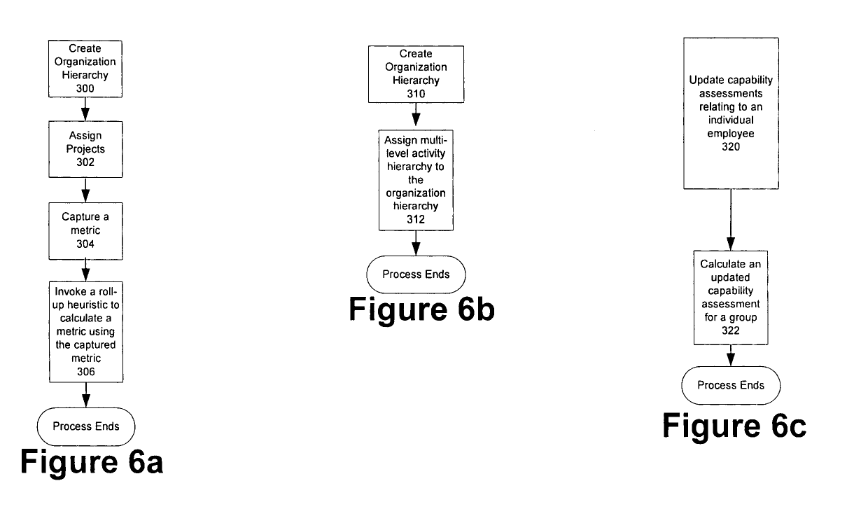

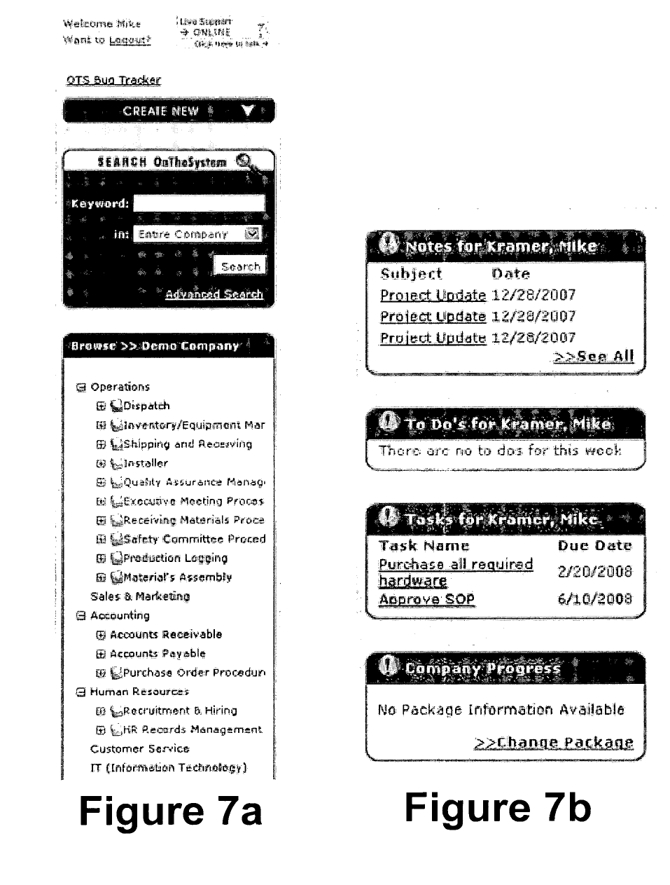

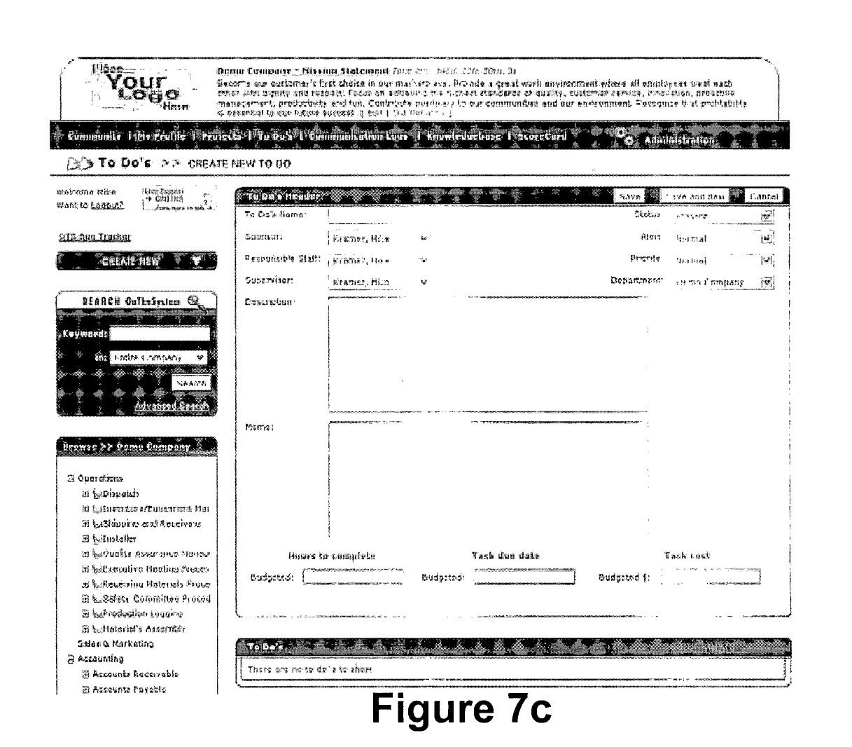

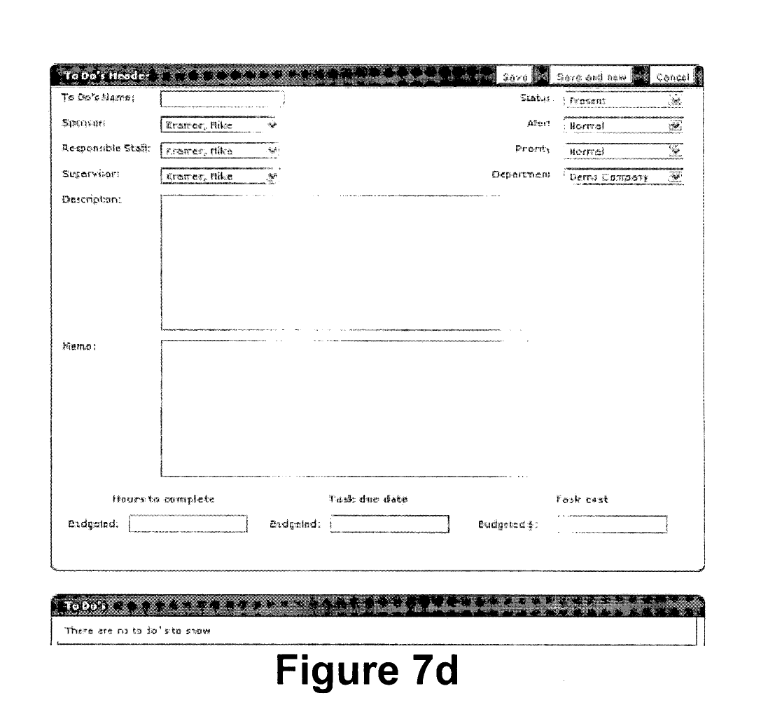

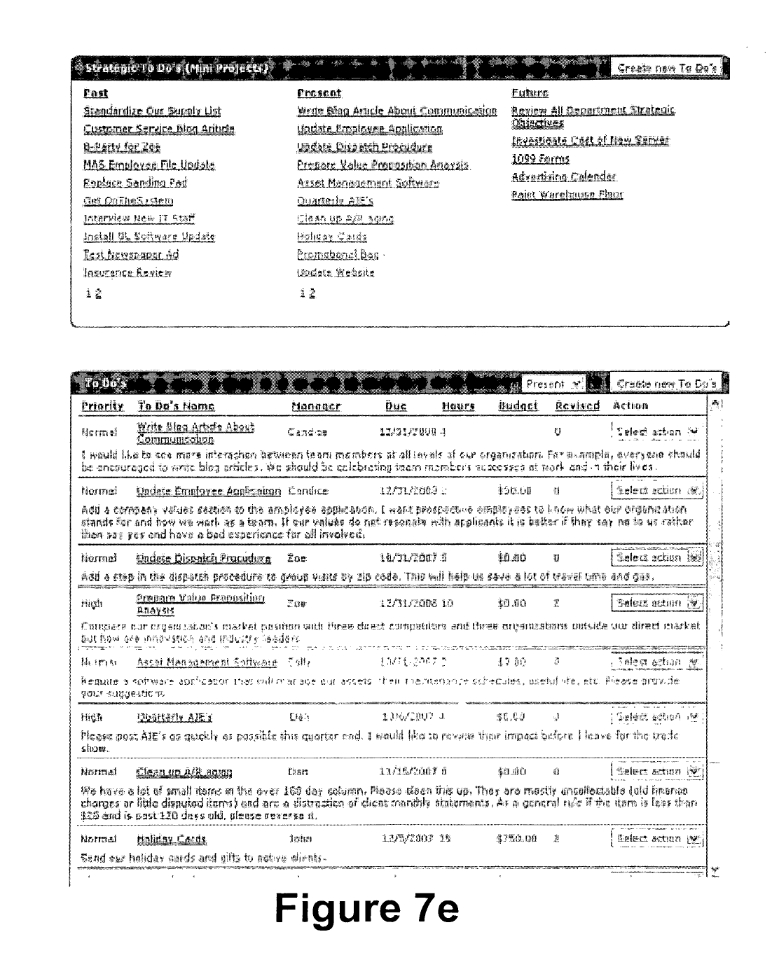

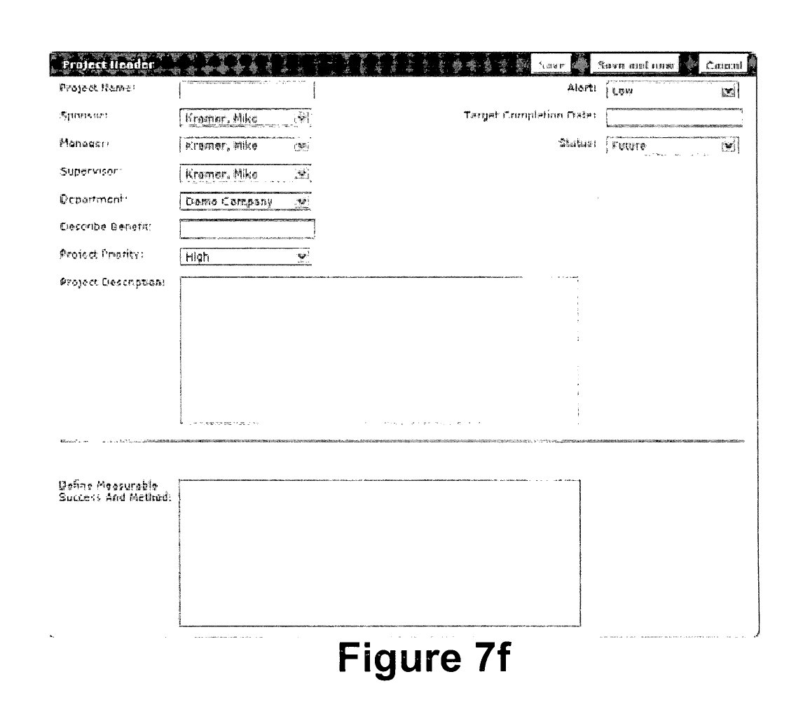

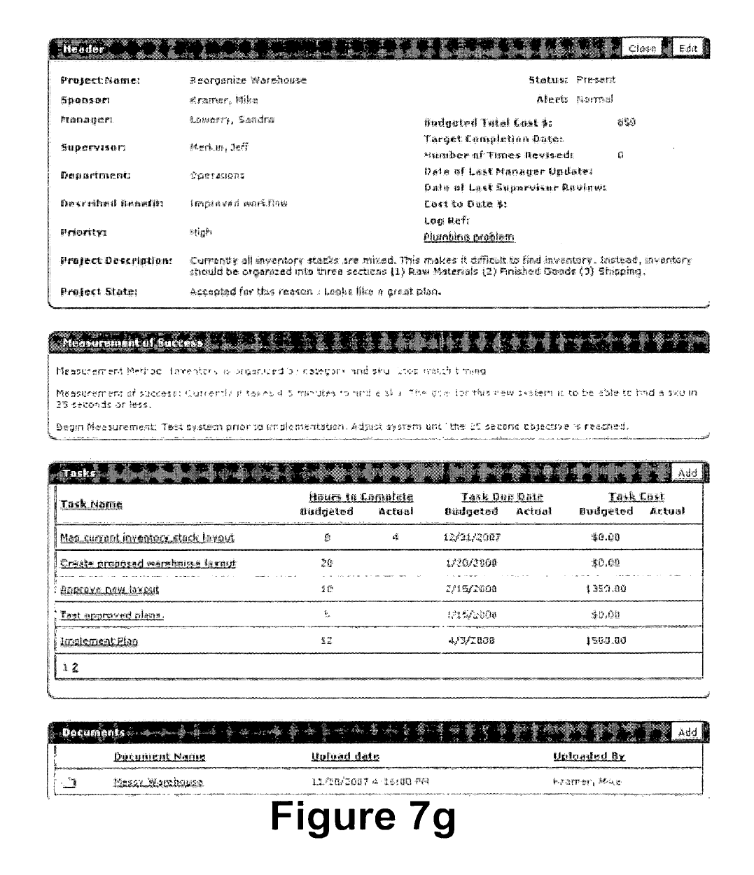

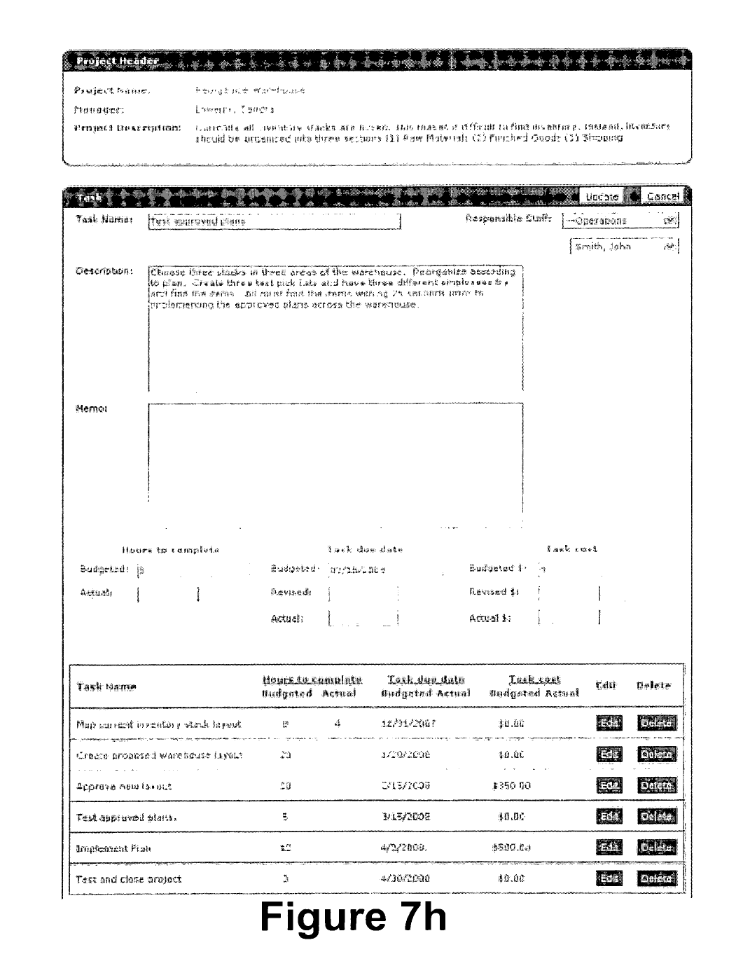

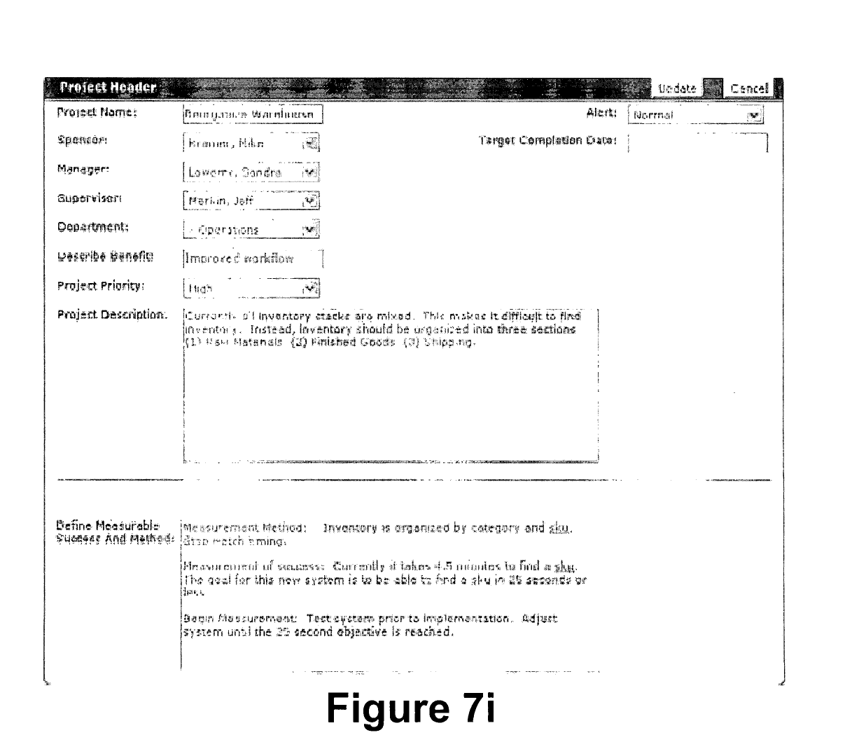

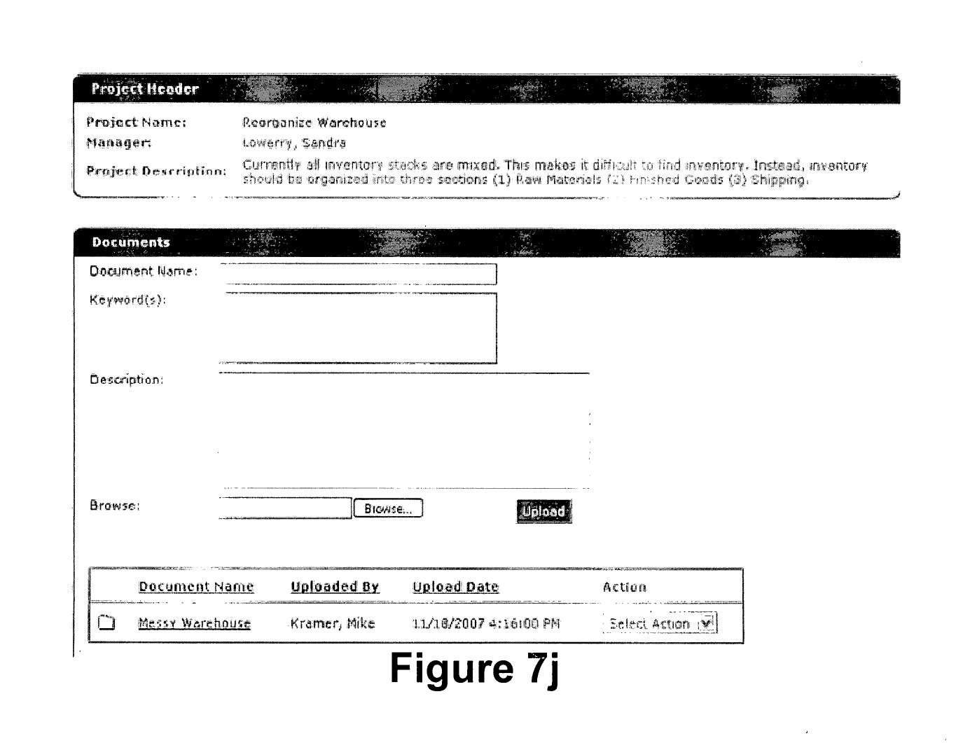

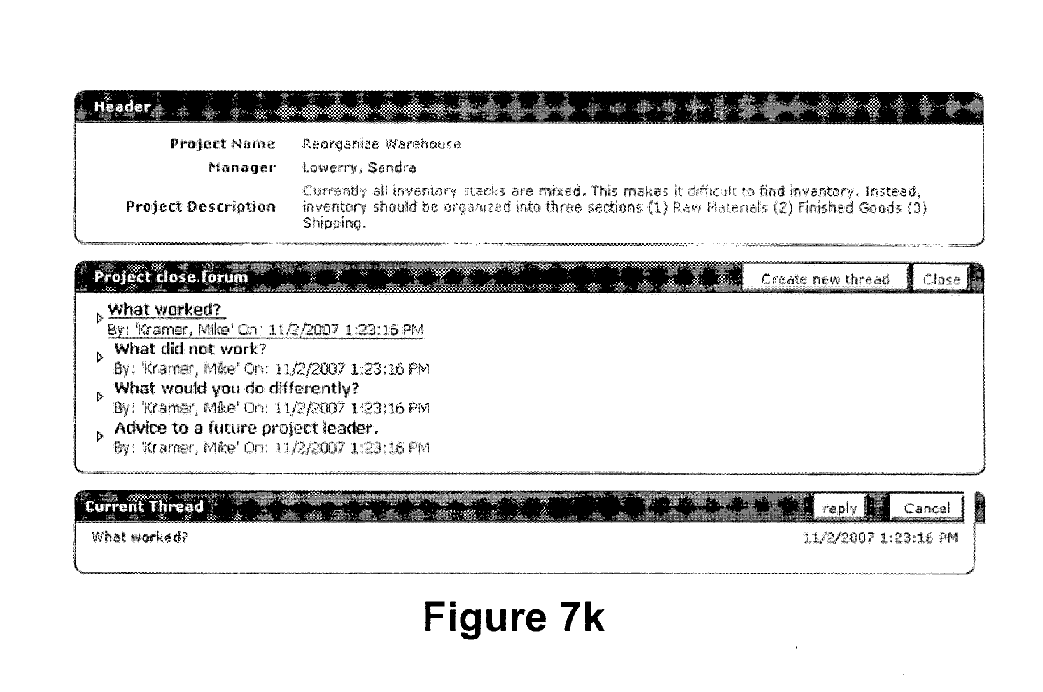

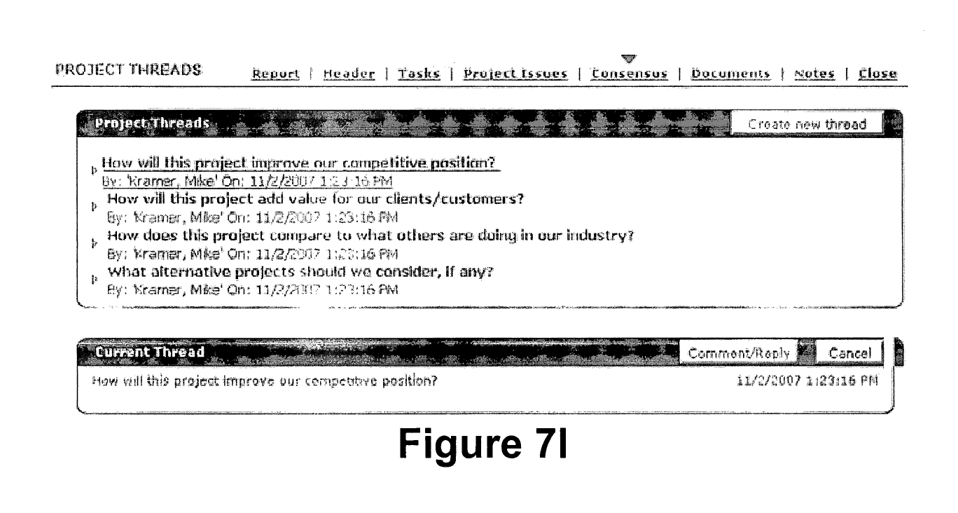

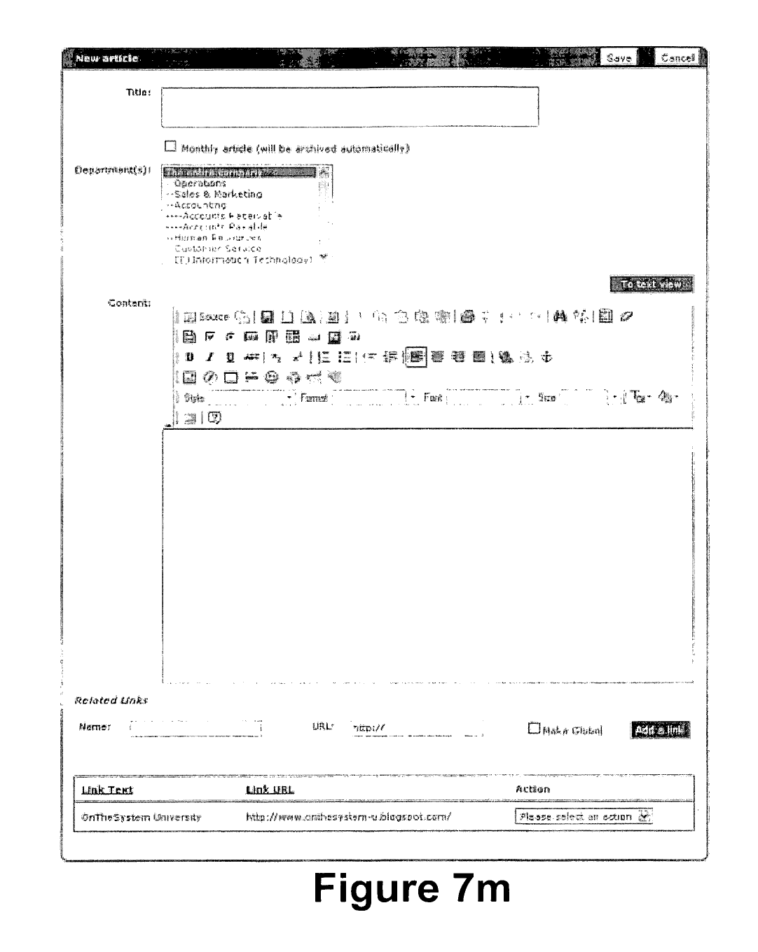

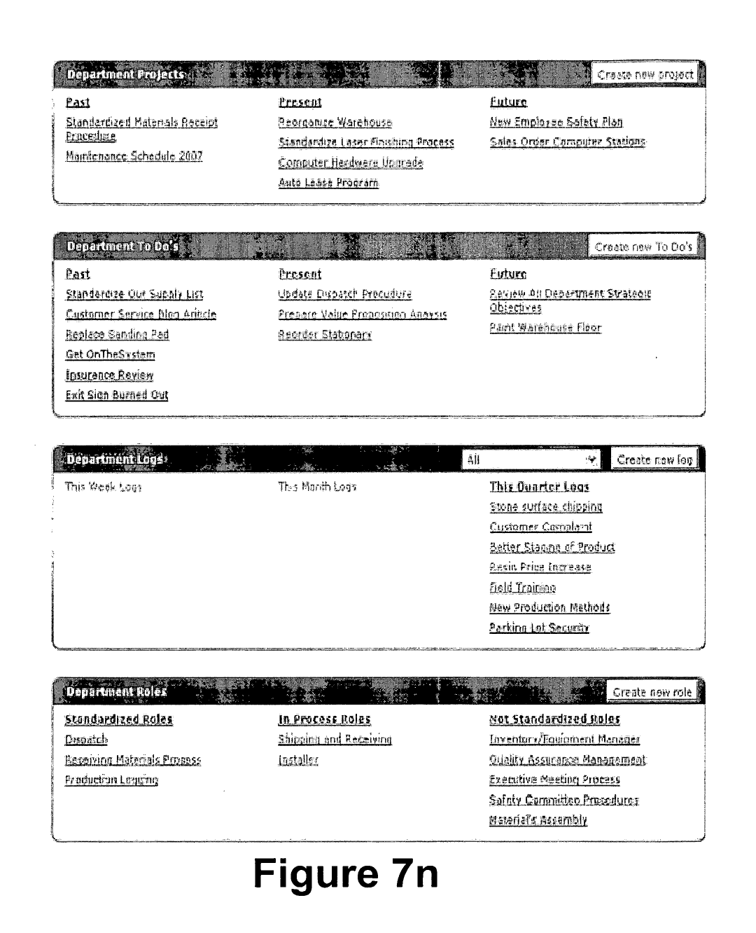

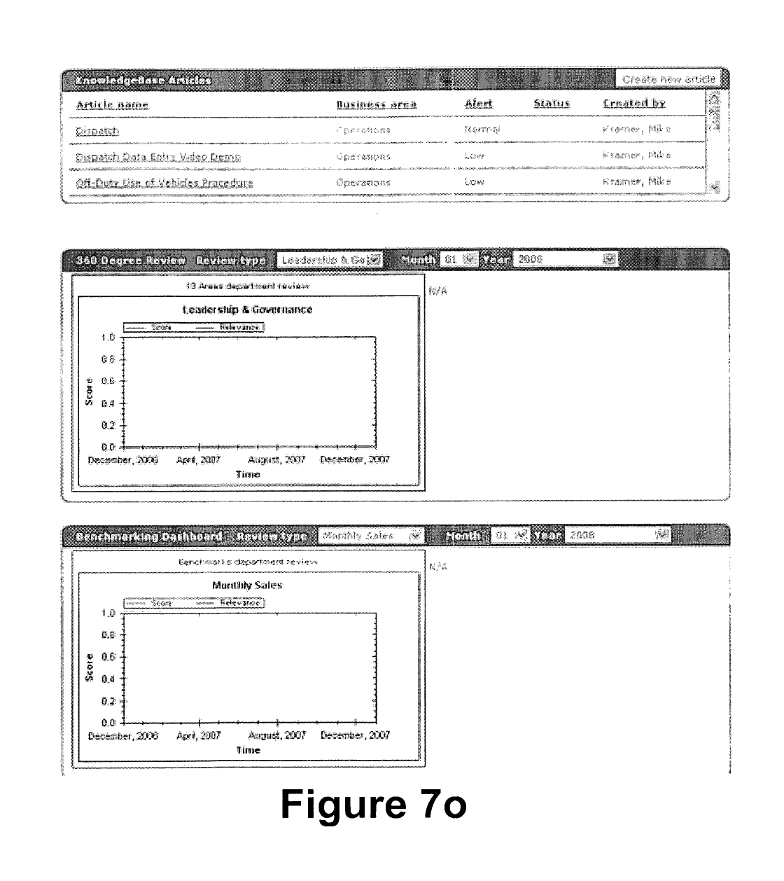

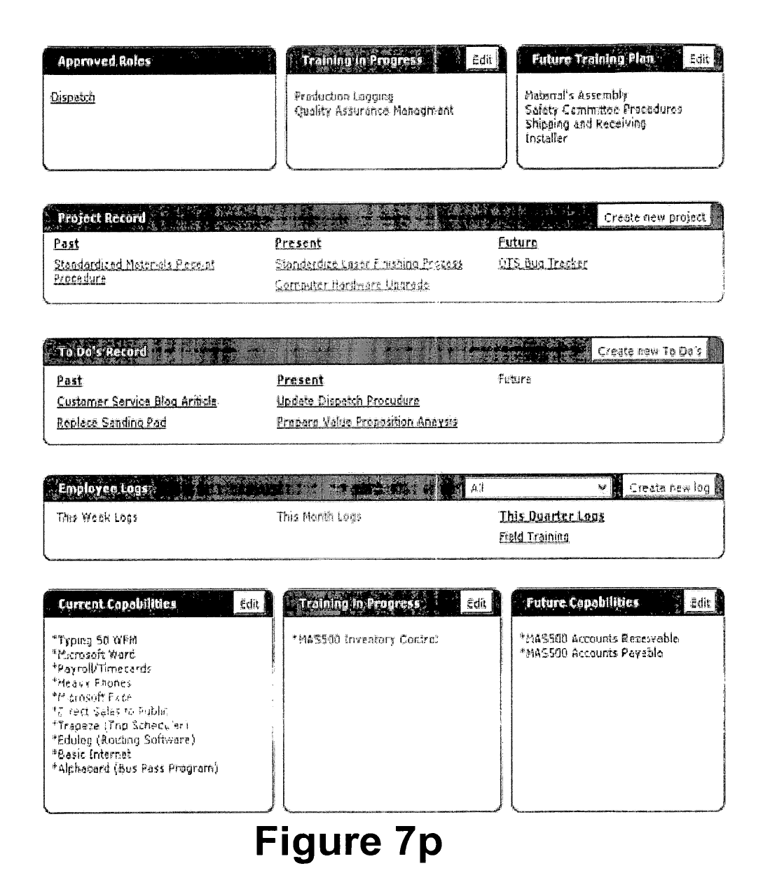

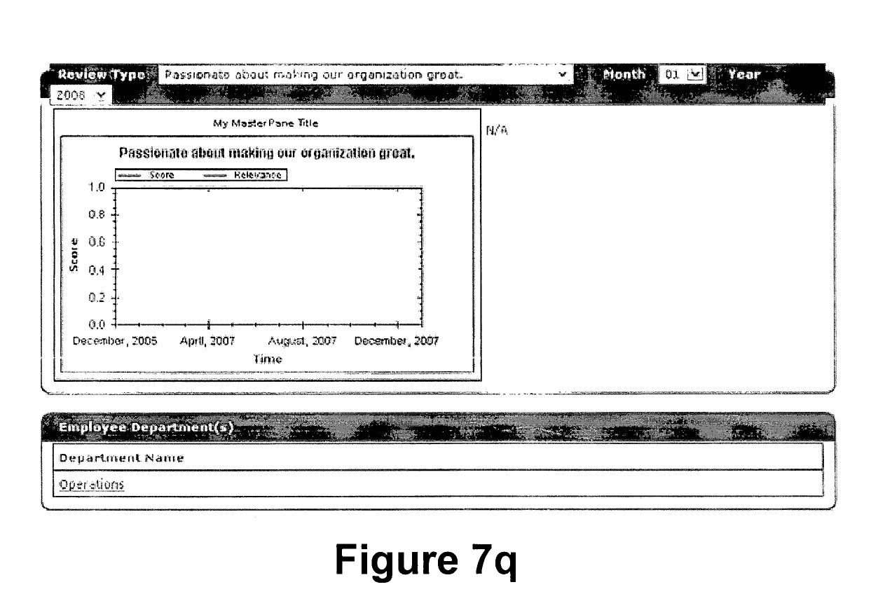

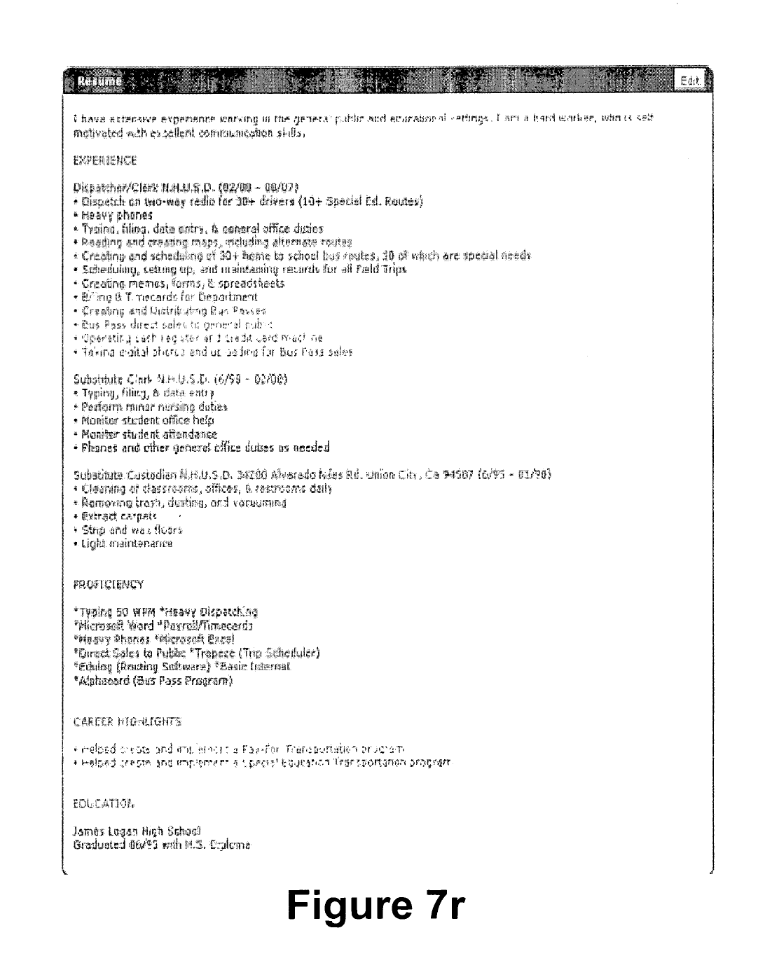

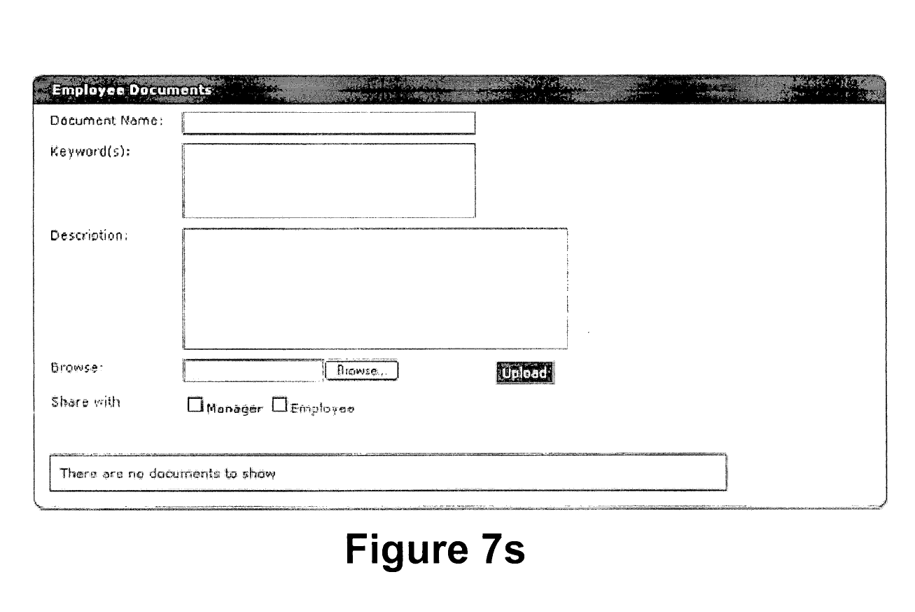

FIG. 1 is an environmental diagram illustrating an example of certain hardware components that can be used to implement a system 100 and some data elements that can be incorporated into the processing of the system 100. The system 100 can be implemented in a wide variety of different hardware configurations and in a wide variety of different organizational contexts. Different embodiments of the system 100 can involve substantially different configurations of data elements.

A. Organizations

The system 100 allows organizations to better manage the activities of the organization. Some organizations can be composed of as few as a single individual at a single location while others may have thousands or even millions of personnel dispersed throughout the globe. Examples of organizations that can benefit from use of the system 100 include businesses, government agencies, non-profit groups, religious institutions, community organizations, non-governmental organizations, education institutions, professional associations, and other types of organizations (collectively “organizations”). In some embodiments of the system 100, an organization will operate the system 100. In other embodiments of the system 100, an outside entity, such as an application service provider (“ASP”) will operate the system 100 for the benefit of one or more organizations. Most of the data elements in FIG. 1 are specific to a particular organization. For example, each organization can use the system 100 to define a particular rule 144 or a status 140 that impacts the processing of the system 100 with respect to that particular organization. However, it is possible for the system 100 to be configured in such a manner as to include inter-organization as well as intra-organization processing. For example, the system 100 can be configured to generate a benchmark metric 150 that is generated from multiple organizations. Similarly, an administrator 112 of the system 100 can define a system-wide rule 144 that would be applied to all organizations using that particular embodiment of the system 100.

B. Users and Administrators

1. Users

A user 102 of the system 100 is typically a human being who is associated in some way with an organization that is utilizing the system 100. Common examples of users 102 can include employees, contractors, executives, directors, owners, partners, consultants, and members (collectively “personnel”). In some embodiments of the system 100, users 102 can include personnel affiliated with the vendors or customers of the organization. Some embodiments of the system 100 may include non-human users 102, such as industrial robots, online avatars, neural networks, artificial intelligence components, expert systems, barcode readers and other devices for tracking objects (collectively “non-human users”). Virtually any source of data can be integrated into the processing of the system 100 in order to enhance the benefits of using the system 100 for one or more organizations.

2. Administrators

An administrator 112 is a user of the system 100 who is authorized to configure the system 100. In many embodiments of the system 100, the administrator 112 is not associated with an organization utilizing the system 100 but is instead associated with the entity (such as an ASP) making the system 100 available to the organization. Administrators 112 are typically personnel, although non-human users can also serve as administrators 112.

C. Access Devices

An access device 104 is any device capable of allowing communication with the system 100. Users 102 can interact with the system 100 through a wide variety of different access devices. Different interactions and functions may influence the suitability of a particular access device 104. For example, in some circumstances cell phone may be an acceptable access device 104 while in other circumstances use of a keyboard such as that used in desktop computing would be desirable. Different organizations and different users 102 can use different access devices 104 to interact with the system 100. In many embodiments, the various access devices 104 are client devices on a computer network, such as the Internet. Access devices 104 can include desktop computers, laptop computers, mainframe computers, cell phones, satellite pages, personal digital assistants (“PDAs”), remote e-mail devices, or other devices (collectively “computer access devices”). In some circumstances, access devices can also be non-computer devices, such as fax machines, standard telephones with computerized answering options, and other communication mechanisms (collectively “non-computer access devices” 104). For many embodiments of the system 100, certain interactions may require access to a web page, and thus the access device 104 will need to be able to provide access to the World Wide Web or similar network. In many embodiments of the system 100, only limited access to the system 100 can be obtained through the use of non-computer access devices.

An administrator access device 114 is any access device 104 used by an administrator 112.

D. Interfaces

Access devices 104 are the hardware devices that allow interaction with the system 100. Interfaces 106 are the foundational software mechanisms (e.g. operating instructions) that allow the hardware devices to support interactions with the system 100. Web pages and graphic user interface (“GUI”) screens are common examples of interfaces 106 in computer access devices 104. In many embodiments of the system 100, the interfaces 106 can include a wide variety of different and even overlapping interfaces. Different parts of an organization hierarchy 128 can each be associated with their own views because each part of an organization hierarchy 128 is focused on different information or levels of information that are relevant to the organization.

Even a single embodiment of the system 100 can use a variety of different interfaces 106. Some embodiments of the system 100 allow users 102 to customize their respective interfaces 106 so that different interfaces 106 display different views of the organization and its activities.

An administrator interface 116 is an interface used by an administrator to interact with the system 100. To some extent in certain limited circumstances, can be necessary for administrators to directly interact with the source code or database tables that underlie the system 100 in order for the administrator 112 to interact with the system 100 as an administrator 112.

E. Application

One or more software applications 120 can be used to provide the functionality of the system 100. In some embodiments, the applications 120 are in the form of computer programs and other software files (collectively the “application” 120) that can be run on general purpose computers. In alternative embodiments, the applications 120 could be implemented in the form of embedded computers, programmable logic devices, or other forms of hardware. Although multiple organizations can run and rely upon identical applications 120 with data and processing rules 144 configured by the organizations in an organization-specific manner, typically only a single entity such as an ASP is responsible for creating, maintaining, and updating the application 120. Other entities typically impact application functionality only through use of the application 120, not through access to source code or other information technology components of the system 100.

The application 120 can be written in a wide variety of programming languages. In many embodiments, an object-oriented programming and/or web-based-language is used to create the application. If the system 100 utilizes the Internet or other type of computer network, it can be helpful to use a programming language conducive to the creation of web pages.

F. Computer

A computer 122 is any device or collection of devices and surrounding peripherals that can house and run the application 120 needed to functionality of the system 100. In many embodiments, the computer 122 is a server accessible from various client locations so long as the appropriate security validation is successfully performed. In many embodiments, the computer 122 comprises one or more secure web server.

Examples of computers 122 include servers, desktop computers, laptop computers, mini-computers, micro-computers, mainframe computers, programmable logic devices, embedded computers, work stations, LANs, WANs, and any other device or network capable of running the application 120 and interacting with one or more databases 124.

G. Database

A wide variety of different databases 124 can be used to store information used by the system 100. The database 124 can be virtually any mechanism or technique for storing and retrieving data. In a preferred embodiment, a relational database is used as the database 124 for the system, but object-oriented databases, hierarchical database, arrays, and flat file storage strategies can also be used. In some embodiments of the system 100, the system 100 avoids creating duplicate copies of information, and instead links to the original sources for the information.

The data designs incorporated into the database 124 can vary widely from embodiment to embodiment. The more sophisticated the rules 144 and processes 119 used by the system 100, the more “normalized” the database will generally need to be.

The system 100 typically performs its functions by creating, accessing, updating, and deleting a wide variety of different information that is stored on the database 124. Such information can be referred to collectively as data elements.

H. Management Tool

The system 100 and its affiliated functionality and structure can be referred to as a management fool 120 that resides in an information technology operating environment.

1. A management system that provides for residing on a server and being accessible from a plurality of access devices, comprising:
an activity subsystem, wherein said activity subsystem provides for a plurality activities and a plurality of metrics, wherein said activities include a first activity and a second activity, wherein said metrics include a first metric associated with said first activity and wherein said metrics include a second metric associated with said second activity; and
an organization subsystem, wherein said organization subsystem provides for a plurality of groups and a plurality of resources; wherein said groups includes a first group and a second group, and wherein said resources include a first resource associated with said first group and a second resource associated with said second group;
wherein said first activity is associated with said first group;
wherein said second activity is associated with said second group;
wherein said second metric influences the determination of said first metric.

2. The management system of claim 1, wherein said plurality of groups of includes an accounting group, a marketing group, a sales group, a purchasing group, and a human resource group, and wherein said accounting group includes an accounts receivable group and an accounts payable group.

3. The management system of claim 1, wherein said second activity is a subset of said first activity and wherein said second group is a subset of said first group.

4. The management system of claim 1, wherein said plurality of activities are organized in a hierarchy of activities and wherein said plurality of groups are organized in a hierarchy of groups.

5. The management system of claim 1, wherein said hierarchy of activities is at least three levels deep and wherein said hierarchy of groups is at least three levels deep.

6. The management system of claim 1, wherein said first resource is an employee, and wherein said second activity is associated with a name, a manager, an actual hours, a completion estimate, a due date, a budget cost, and an actual cost.

7. The management system of claim 1, wherein said first activity is associated with a plurality of documents, wherein said first group is associated with a procedure, and wherein said procedure is automatically applied to said second group.

8. The management system of claim 1, wherein said first resource is an employee, wherein at least one said activity is a training activity, and wherein a role is added to said employee upon completion of said training activity.

9. The management system of claim 1, further comprising an interface subsystem, wherein said interface subsystem provides for a plurality of views, wherein said plurality of views includes a first view, a second view, and a third view, wherein said first view is associated with said first group, wherein said second view is associated with said second group, and wherein said third view is associated with said first resource.

10. The management system of claim 1, further comprising a capabilities subsystem, wherein said capabilities subsystem provides for a plurality of capability assessments, wherein said capability assessments include a plurality of present capability assessments and a plurality of future capability assessments, and wherein said first metric is influenced by at least one said capability assessment.

11. The management system of claim 1, further comprising a procedures subsystem, wherein said procedures subsystem provides for a plurality of procedures, a plurality of definitions, and a plurality of exceptions, wherein said procedures subsystem provides for associating said procedures with said groups, wherein said procedures subsystem provides for associating at least one said procedure with at least one said exception and at least one said definition, wherein at least one said procedure is associated with a benchmark metric.

12. The management system of claim 11, wherein said procedures subsystem further provides for a plurality of procedure categories and wherein at least a subset of said procedures are associated with at least a subset of said procedure categories.

13. The management system of claim 1, further comprising a roll-up heuristic that provides for displaying an aggregated metric and a roll-down heuristic for displaying a plurality of non-aggregated metrics.

14. The management system of claim 1, further comprising a plurality of statuses, said plurality of statuses including an activity status associated with said first activity, a training status associated with said first resource, and a capability status.

15. The management system of claim 1, wherein said plurality of activities includes an objective, a plurality of projects associated with said objective, a plurality of tasks associated with said plurality of projects, and a plurality of documents associated with said plurality of tasks.

16. The management system of claim 1, further comprising a procedures subsystem, a communications subsystem, a capabilities subsystem, and an interface subsystem;
wherein said organization hierarchy, wherein said organization hierarchy includes an entity, a department, a team, a role, and an individual;
wherein said activities subsystem includes a project, a task, and a document;
wherein said procedures subsystem includes for a plurality of procedures, a plurality of definitions, and a plurality of exceptions, wherein said procedures subsystem provides for associating said procedures with said groups, wherein said procedures subsystem provides for associating at least one said procedure with at least one said exception and at least one said definition, wherein at least one said procedure is associated with a benchmark metric;
wherein said communication subsystem provides for creating, sending, and receiving a plurality of communications, wherein access and distribution to said communications is influenced by at least one of a plurality of distribution lists that are associated with one or more said groups, wherein said plurality of communications are organized into a plurality of communication categories, wherein each said communication is associated with a priority and an information source;
wherein said capabilities subsystem provides for storing a plurality of capability assessments, said plurality of capability assessments including a plurality of capability assessments, a plurality of present capability assessments, and a plurality of future assessments, wherein at least one said capability assessment is associated with at least one said group, wherein said capability assessments are organized into capability categories; and
wherein said interface subsystem provides for a plurality of user interfaces, wherein said user interfaces are associated with said plurality of groups, wherein said user interfaces are influenced by a plurality of permissions, wherein said interface subsystem provides for displaying an entity view of aggregated metrics that are influenced by said projects, said capability assessments, said communications, and said procedures.

17. A management system, comprising:
a software application, wherein said software application provides for accessing a database and residing on a server;
wherein said software application provides for creating:
an organizational hierarchy, wherein said organization hierarchy provides for a plurality of groups, wherein said groups includes a first group and a second group, and wherein said first group includes said second group;
a plurality of projects, wherein at least one said project is associated with at least one said group;
a plurality of tasks, wherein at least one said task is associated with at least one said project;
a plurality of documents, wherein at least one said document is associated with at least one said task;
a plurality of metrics, including a first metric and a second metric, wherein said first metric is associated with at least one said project, wherein said second metric is associated with at least one said second task, and wherein said first metric is influenced by said second metric.

18. The system of claim 17, wherein said plurality of metrics includes an entity metric, a department metric, a team metric, a role metric, and an individual metric;
wherein said software application provides for a communication log interface and a plurality of communications, wherein said communications are organized into a hierarchy of topics, and wherein each said communication is associated with a priority, an information source, an open date, and a close date;
wherein said communication log interface provides for sending automated communications that include one or more said metrics;
wherein at least one said project is associated with a project name, a manager, a deadline, a number of hours, a budget, and a status;
wherein software application provides for a plurality of capability assessments, wherein said metrics include a relevance metric and a score metric, wherein at least one said capability assessment is associated with at least one said group, wherein at least one said capability assessment is associated with said relevance metric and said score metric;
wherein said software application further provides for a plurality of rules, plurality of events associated, and the display of a calendar, wherein said software application provides for using said rules to selectively display said events on said calendar;
wherein at least said project is associated with a sponsor, a manager, a department, a status, a priority, a benefit, a success criterion, an alert, more than five tasks, and more than five documents;
wherein said software application further provides for creating and updating a plurality of standard operating procedures, wherein said standard operation procedures can be associated with a subset of said organization hierarchy;
wherein said software application further provides for a plurality of procedure categories, a plurality of sub-processes, and a plurality of step descriptions;
wherein said software application provides for displaying a user interface that is influenced by one or more groups associated with said user interface through a login process, wherein said user interface provides for displaying a list of past projects, a list of present projects, a list of future projects, a list of tasks, and a list of communications;
wherein at least one said task is the training of an employee, and wherein upon completion of the training, a new role is added to the applicable employee record;
wherein said software application further provides for a plurality of statuses, including a project status, a task status, a training status, and a capability status;
wherein said plurality of projects include an improvement initiative, a strategic plan, and a daily operation; and
wherein said software application further provides for invoking a roll-up heuristic to display an aggregated metric and a roll-down heuristic to display a plurality of non-aggregated metrics.

19. The system of claim 17, wherein said organization hierarchy is at least three levels deep, further comprising an activities hierarchy that is at least three levels deep.

20. A method of managing information on a computer network, comprising:
defining an organization hierarchy on a database, wherein said organization hierarchy includes a plurality of groupings, wherein said plurality of groupings includes an entity, a department, a team, a role, and an individual level, wherein said groupings are associated with a plurality of permissions;
creating a project on said database, wherein said project is associated with at least one said group, a plurality of tasks, a project sponsor, a project measurement method, a project status, and a project budget, wherein said plurality of tasks are associated with plurality of task time budgets, a plurality of task due dates, and a plurality of task costs, wherein at least one said task is associated with a document;
storing a communication log on said database, wherein said communication log includes a plurality of communications, a plurality of topics, and a plurality of distribution lists, wherein said plurality of communications include a priority and an information source, wherein at least one said topic is associated with at least one said grouping, wherein said plurality of distribution lists correspond to said plurality of groupings, and wherein at least one said communication is associated with at least one said project;
capturing a plurality of capability assessments on said database, wherein said capability assessments are selectively displayed using said permissions and said groupings, wherein said capability assessments are organized into a plurality of capability categories, wherein at least one capability assessment is associated with a capability relevance metric and a capability score metric;
describing a plurality of procedures on said database, wherein at least one said procedure is associated with at least one said grouping, at least one said function, a preparer, an approver, a quality objective, an approval date, a benchmark metric, and at least one said document; and
automatically generate at least one of: (a) a grouping metric associated with one or more said groups; and (b) a project metric associated with one or more said projects.
